(19) United States
(12) Patent Application Publication
(10) Pub. No.: US 2023/0358414 A1
(43) Pub. Date: Nov. 9, 2023

(54) Grid Independent Heating System and Method for Buildings that uses Collector Accumulator and Transformer (CAT)

(71) Applicants: Julio Cesar Guerrero, Cambridge, MA (US); William Martin Worek, Darien, IL (US)

(72) Inventors: Julio Cesar Guerrero, Cambridge, MA (US); William Martin Worek, Darien, IL (US)

(73) Assignee: Cambridge Research and Technology L.L.C., Cambridge, MA (US)

(21) Appl. No.: 17/662,429

(22) Filed: May 7, 2022

(51) Int. Cl. F24D 11/00; F24S 10/50

(52) U.S. Cl. CPC F24D 11/007; F24S 10/50; F24S 60/00

(57) ABSTRACT

The system and method to maintain the temperature inside a building or house within comfort levels independently of the Grid. The system has a collector; an accumulator; and a transformer, which is the building or house. The method consists of transforming energy from solar radiation into thermal energy, accumulating that energy into an accumulator, and using that accumulated thermal energy to warm the internal environment of buildings or houses. One of its loops functions between dawn and sunset and includes only the collector and the accumulator; its second loop includes only the accumulator and the transformer and operates primarily between sunset and dawn. The collector uses a blackened surface to transform sun's radiation into thermal energy to warm air that is used to conduct the thermal energy throughout the system. The system can be built with inexpensive material; utilized in significantly isolated areas; and constructed and assembled on site.

### BACKGROUND OF THE INVENTION

This invention is related to the field of grid independent energy systems. Specifically, this is related to heating systems that do not require electricity or hydrocarbon provided by the grid to warm houses or buildings in isolated and remote areas. Even more, this invention relates to systems that can be manufactured at relatively low costs and can be assembled on site. Since one embodiments of the system can use rocks inside a container to store the collected thermal energy, it makes easy to make without sophisticated manufacturing processes. There are several expressions of previous art, but none of them have the key innovative characteristics of this one, all in one system: namely:
1. Wall integrated thermal solar collector with heat storage capacity US20050061312A1 Link to patent: https://patents.google.com/patent/US20050061312
2. Solar energy collector and thermal storage device WO2011044014A1 Link: https://patents.google.com/patent/WO2011044014A1/en
3. Trombe Wall

A Trombe wall is a massive Equator-facing wall that is painted a dark color in order to absorb thermal energy from incident sunlight and covered with a glass on the outside with an insulating air-gap between the wall and the glaze. http://hiddenarchitecture.net/ungreen-trombe-wall/Some of the differences between US20050061312A1″Wall integrated thermal solar collector with heat storage capacity” and this patent are that the US20050061312A1: 1) is not modular and does not allow to dimension the collector and accumulator depending on the geographical position where the house or building is; 2) does not allow to accumulate thermal energy for more than one night of use or for variability of the solar radiation during the days; and 3) is not easy to dimension and manufacture, and assembled on site by mostly unskilled people. The Solar energy collector and thermal storage device WO2011044014A1 has the same limitations as US20050061312A1, and in addition: 1) it cannot store enough thermal energy to warm a house for more than a few hours; and 2) it does not allow to orient the collector in the optimum direction with respect the north-south line and it cannot be inclined with respect to the horizontal plane to maximize the transformation to solar radiation into thermal energy. The Trombe wall has all the limitations of the first two just analyzed above.

### SUMMARY OF THE INVENTION

This invention distinguishes from other inventions and from what is old in that it is modular; can be dimensioned to provide with enough thermal energy for more than one day to warm a house or building that is not connected to the grid; can be assembled on site; can be manufactured with mostly inexpensive materials, which makes it a good solution for mostly deprived or isolated areas; its collector can be easily and optimally oriented with respect to the north-south line and with respect to the horizontal plane to maximize exposure to solar radiation and thermal energy generation.

This patent (1) discloses a system and a method to maintain the temperature inside a building or house within comfort levels independently of the Grid. The system has three main components: a collector (C), an accumulator (A), and transformer (T). The method consists on transforming energy from solar radiation through a collector (C) into thermal energy, accumulating that energy into an accumulator (A), and transforming that accumulated energy into thermal energy to later warm the internal environment of buildings. One embodiment of the system has two loops. The first of those two loops functions between dawn and sunset and includes only the collector (C) and the accumulator (A). The second loop includes only the accumulator (A) and the transformer (T) and operates primarily between sunset and dawn. The first embodiment has only one of the two loops working at a time. In the first loop, its collector (C) uses a blackened surface that transforms the energy coming from the sun in the form of radiation into thermal energy that increases the temperature of air that is in contact with the blackened surface. The air whose temperature has been increased in the collector is moved to an accumulator (A). One embodiment of the accumulator (A) uses rocks in which the heat is conserved during the day; however, this does not exclude other materials to be used to store the thermal energy inside the accumulator (A). When the accumulated thermal energy is needed to warm up the interior of a building, which we refer to as the transformer (T), the second loop is activated between the accumulator and the building into which the energy is transferred to increase its internal temperature with respect to the surrounding ambient. FIG. 1A shows a schematic of the method and system of main embodiment showing its three main modules. The system uses a small amount of electric energy to power a mostly small blower (BW) to blow air inside the system to carry the thermal energy throughout the three modules. The electric energy can be collected from one small solar collector (SC) or an alternative energy harvesting device that can be used in isolated out-of-the-grid areas.

This invention brings several unique innovative characteristics that are not found integrated in an integrated system in previous art; namely, the system of this invention can operate independently of the grid. Besides, the system and method of this invention can help to deliver clean energy to historically overburdened and underserved communities worldwide. Additionally, the system of this invention is modular, and each of its three main modules, the collector (C), the accumulator (A), and the transformer (T) can be dimensioned and built separately and integrated in the full system to perform depending on the requirements determined by the user. Besides, the modules and therefore the system can be built with relatively inexpensive material. The system of this invention can be utilized in extremely cold and isolated areas where there is not access to the Grid; does not rely on solar panels (SP) to generate the thermal energy; and its modules or the entire system can be constructed and assembled on site.

### Specifications

In its main embodiment, the collector (C) is a box with three parallel surfaces. The top an outer most surface and the one next to it have a gap between them. The top and outer most surface is made of a transparent material that allows for the sunlight and radiation to cross it. The middle surface is black in color on the side that faces the top and outer most surface. The gap between both surfaces uses the greenhouse effect to transform the solar energy that arrives as radiation into thermal energy that warms the black surface. Behind the middle surface, between it and the third and last surface, there is air, which is warmed as it gets in contact with the back side of the back surface. (Rectangular funnel) The air behind the blackened surface increases its temperature. There is a loop that connects the collector and the accumulator (A). In its main embodiment, this loop connects the collector (C) with the accumulator (A) by means of conduits through which the air flows from the collector (C), traverses the material inside the accumulator from top to bottom, which in its main embodiment is rocks; runs back from the bottom of the accumulator (A) into the collector (C); and after the air circulates through the collector (C), it is sent back to the Accumulator (A). This loop is kept running between dawn and sunset. This process warms the material inside the accumulator (A), increases its average temperature above the ambient temperature, allows to accumulate the thermal energy collected by the collector inside the accumulator (A), so it can be used to warm the building—the transformer (T) when needed. The system has valves (V) that allow to turn on or off the loops as needed. This allows the collection and accumulation of energy, between the collector (C) and the accumulator (A); and the warming of the building interior when passing the accumulated energy from the collector (C) to the transformer (T) when needed.

The best performance is achieved when the collector (C) is placed in a specific alignment, when its longitudinal axis is aligned along the North-South orientation, and an it has an inclination with respect to the horizontal plane as a function of the Longitude and Latitude coordinates of the place where the building to be warmed is. The collector (C) can be placed in almost any place near the building including on top of its roof; however, it is recommended to avoid as much as possible a position that occludes the sunlight due to shades produced by buildings or other elements between dawn and sunset. The accumulator (A) can be placed in any place outside and near the building that it will warm; however, it can also be placed inside the building. Whatever relative position between Collector (C), Accumulator (A) and Transformer (T), it is recommended to minimize the length of tubing that connects them so as to minimize energy loses due to the exposure of the tubing to differential temperature across its walls. This system is modular, which allows a variety of combinations to handle different heating energy demands for different environment temperatures and climates. Besides, the system can be made with relatively inexpensive materials, which allows it to be used in relatively deprived areas in the world as well as isolated areas at high altitudes where other sources of energy are not available such as electric or hydrocarbons-based energy. Its modularity allows it to be sized to address energy heating demands of distinct types and sizes of buildings. FIGS. 1A and 1B, FIG. 2, and FIG. 3 show schematics of the main embodiment system and main modules. FIG. 3 remarks that if for example the comfort temperature inside the house of building (T) were 18° C., and the temperature outside the house varied between −5° C. and −20° C. then the delta of temperature the CAT system would have to deal with would vary from 23° C. and 38° C.; however, the CAT system can provide enough thermal energy to maintain the internal temperature at the objective comfort of 18° C.; this example does not exclude other target internal comfort temperatures. The system can achieve warming with different temperatures outside the house. The delta of heating temperature is achieved activating different modules sizes and arrangements. FIGS. 4A and 4B show schematics of the two loops of the main embodiment. The collector (C), the accumulator (A), and the transformer (T) have insulating material that helps to preserve the thermal energy in each of them and the system for several hours. In its main embodiment, the system needs at least one valve (V) to control opening and closing each loop, at least one small blower (BW) to exert pressure on the air that flows in the system's loops, at least one switch (SW) to turn on the heating mode (loop 2) at night from inside the house or building, and a basic electronic control board (EB) with the control features to manage the switch (SW), and solar panel (SP) or alternative device that harvest energy to generate electric energy to power the electric devices. Since the blower (BW), switch (SW), electronic control board (EB), and valve (V)—if they have electric actuation—are electrical devices, the system needs an external source of electric energy; hence the system needs a relatively small solar panel (SP) and battery (BT) that permits generation and accumulation of electric energy in a battery (BT) to get the blower (BW), switch (SW), electronic control board (EB), and valves (V) functioning. FIG. 5 shows the system with the supporting components blower (BW), switch (SW), electronic control board (EB), solar panel (SP) and Battery (BT), valves (V) and conduits (CD) that connect the main components in an exploded view; in this figure, the electronic control board (EB) and the switch (SW) are shown in dashed lines to express that they are inside the house or building.

### DRAWINGS DESCRIPTION

FIG. 1A System diagram of main embodiment showing the three main modules: Collector (C), Accumulator (A) and Transformer (T).

FIG. 1B Main modules Collector (C), Accumulator (A), and Transformer (T) in an exploded view.

FIG. 2 Collector diagram showing the three layers of its main embodiment: top layer, transparent plate; middle layer, black metal sheet, and bottom layer with their key dimensions

FIG. 3 System with its modules and some of the temperature deltas than could be achieved with the system

FIG. 4A Schematics of one of the two loops of the main embodiment; namely, Collector and accumulator (from dawn to sunset) in solid line.

FIG. 4B Schematics of one of the two loops of the main embodiment; namely, Accumulator and Transformer (from sunset to dawn)

FIG. 5 Supporting components in exploded view of one embodiment of the system with the supporting components: blower (BW), switch (SW), electronic control board (EB), solar panel (SP), Battery (BT), valves (V) and conduits (CD) that connect the main; besides, the electronic control board (EB) and the switch (SW) are also shown. The electronic control board (EB) and the switch (SW) are shown in dashed lines to express that they are inside the house or building.

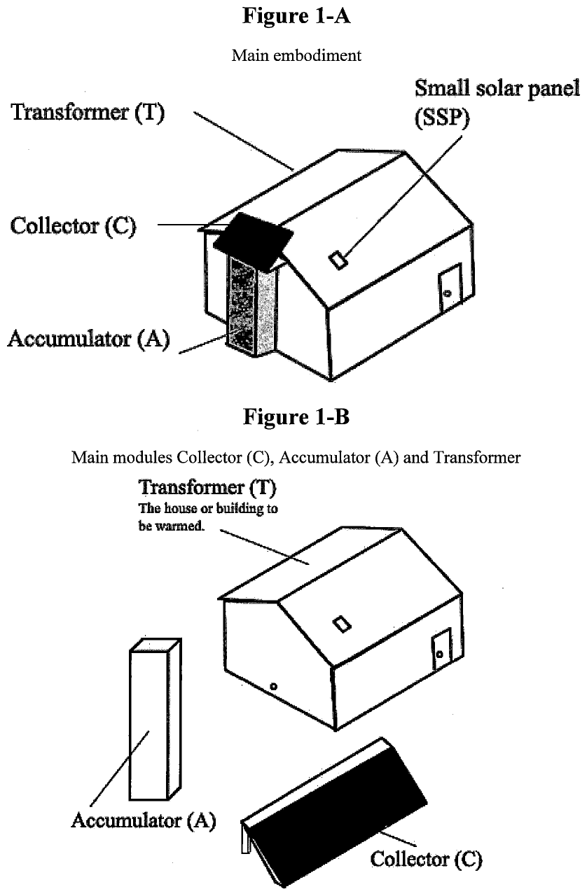

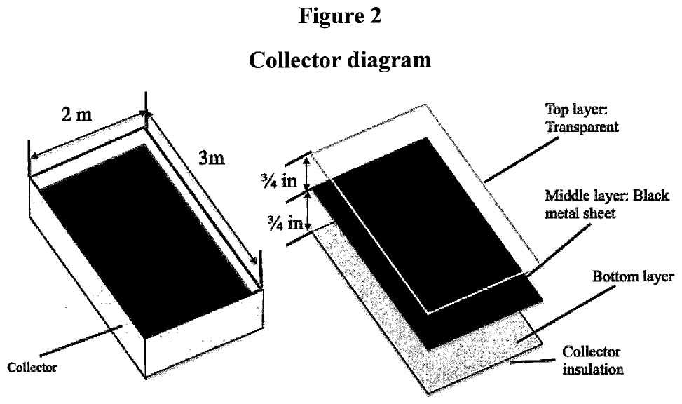

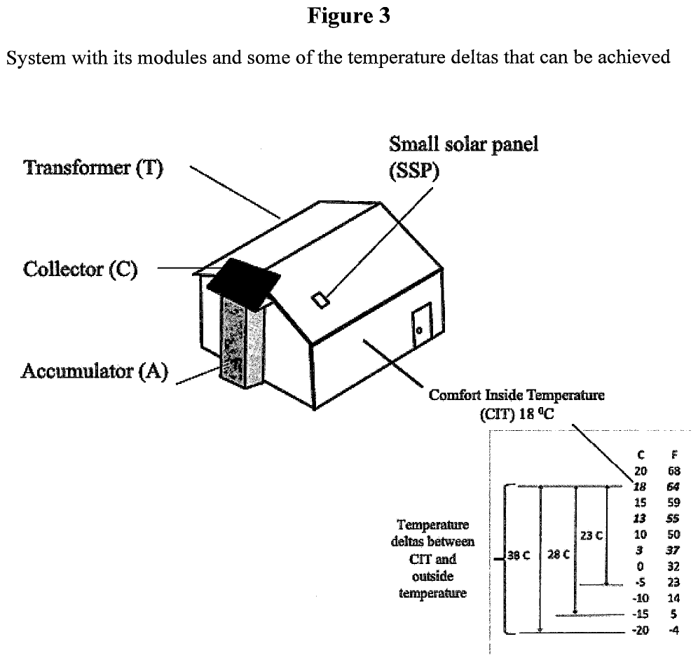

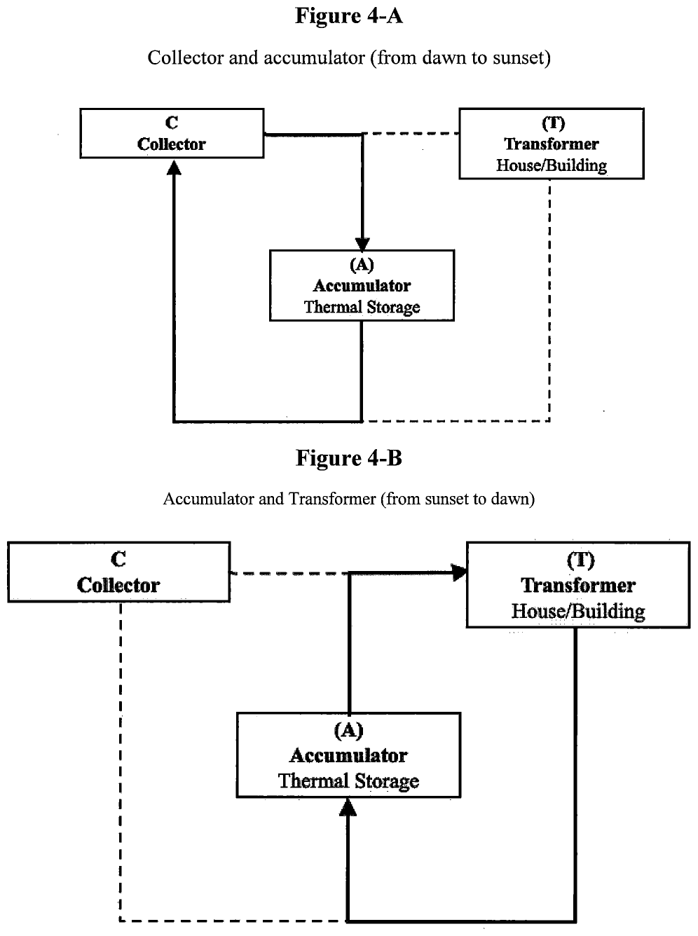

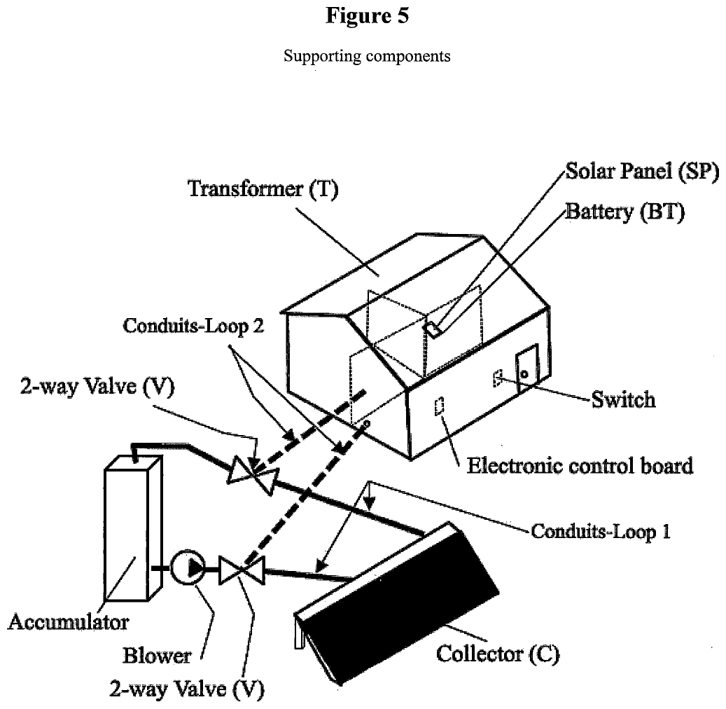

1. A method usable with a house or building, comprising:
Deploying a plurality of solar radiation transforming devices (the collectors (C)) that transform solar radiation into thermal energy in the vicinity of the house or building (the Transformer T) (the transformer);
deploying a plurality of thermal energy accumulating devices—the accumulators— in the vicinity of the house or building (the Transformer T)—the transformer; connecting the plurality of solar radiation transforming devices (the collectors (C)), the thermal energy accumulating devices (the accumulator), and the house or building (the transformer T); and using the set of these connected components to provide the house or building (the Transformer T) with thermal energy to warm the interior environment of the house or building (the Transformer T) to levels that are comfortable for living creatures (people or animals); and based on the required thermal energy necessary to maintain thermal comfort inside the house or building (the Transformer T), selectively choose the number of collectors (C) and accumulators to cause the internal temperature of the house or building (the Transformer T) reach desired levels of comfort as the temperature outside the house or building (the Transformer T) changes depending on the weather and locale where the system is placed.

2. A system usable with a house or building (the Transformer T), comprising:
A collector (C) that transforms solar radiation into thermal energy that is transferred into air that carries the thermal energy into an Accumulator (A) between dawn and sunset; a Transformer (C) that can be a house or building (the Transformer T) that uses between sunset and dawn the thermal energy stored in the air to warm the interior of the Transformer (C); a relative small solar panel (SP) with a battery (BT) and supporting electronic control board (EB) that powers a blower (BW), and an electric switch (SW); and a blower (BW).

3. A system of claim 2, further comprising:
Solar radiation transforming devices—the collectors (C)—that convert the solar radiation into thermal energy by means of a blackened plate placed in parallel and behind at a short distance from a transparent plate that is exposed to the solar light and transfer that thermal energy into the air running in a section of the solar radiation transforming device that is behind the blackened plate of the solar radiation transforming devices.

4. A system of claim 2, further comprising:
Thermal energy accumulating devices—the accumulator (A) devices—that, between dawn and sunset, store the solar the thermal energy carried by the air that has been heated in the collector in a storing thermal energy material as the air traverses the storing thermal energy material; and, during the night, heats the air that is transferred from the house or building (the Transformer T into the energy accumulating devices as the air traverses the energy accumulating device, and sends it back to the house or building—the transformer T.

5. A system of claim 2, further comprising:
Choosing and fixing the angle that the solar radiation transforming devices—the collectors (C)— make with the horizontal plane depending on the longitude and latitude of the area where the house or building (the Transformer T) is located and orienting the longitudinal axis of the solar radiation transforming devices—the collectors (C)—with the North-South line of planet earth to optimize the efficiency of transformation from solar radiation into thermal energy.

6. A system of claim 2, further comprising:
Between dawn and sunset, connecting the collectors (C) and the accumulator (A) in a close loop, and storing in the accumulator (A) the thermal energy collected at the collector by means of conducting air that is warmed in the collector to the accumulator (A); as the warm air from the collector traverses the material in the accumulator (A) from top to bottom, it warms it, after which, it goes to the collector to be warmed again.

7. A system of claim 2, further comprising:
Between sunset and dawn, connecting the accumulator (A) and the house or building (the Transformer T)in a close loop, and using the thermal energy stored in the accumulator (A) to warm the air inside the house or building (the Transformer T)by means of conducting air that is inside the house or building (the Transformer T) into the accumulator (A). As the cold air from the house or building (the Transformer T) traverses the material in the accumulator (A) along its vertical direction, it gets warmed, after which, it goes to the house; the loop is kept until temperature inside the house or building (the Transformer T) reaches the comfort temperature, and it is restarted when the temperature inside the house or building (the Transformer T) goes down.

8. A system of claim 2, further comprising:
Between sunset and dawn, a blower (BW) that blows air only in the space between the middle plate and the bottom plate of the accumulator (A) that then reaches the accumulator (A) and comes back to the collector where the blower (BW) increases again the air pressure; and the same blower (BW) that between dawn and sunset by means of an actuated valve (V) can blow air only between the house or building (the Transformer T) and the accumulator (A) though the connecting conduits between them to allow the system to warm the air inside the house or building (the Transformer T).

9. A system of claim 2, further comprising:
Between sunset and dawn, a relative small solar panel (SP), a battery (BT) connected to it, and an electronic control board (EB) that in conjunction allow to transform solar energy into electric energy and accumulates it in a battery (BT) that powers the blower (BW) that blows air through between the collector (C) and accumulator (A) between dawn and sunset and between the accumulator (A) and the house or building (the Transformer T) between sunset and dawn, and a switch (SW) that allows to turn on the flow of air between the house or building (the Transformer T) and the accumulator (A), which happens through conduits (CD).
